(19) United States
(12) Patent Application Publication
(10) Pub. No.: US 2006/0289519 A1
(43) Pub. Date: Dec. 28, 2006

(54) Microwave cooking package for food products and associated methods

(75) Inventor: Stuart Sharp, Greer, SC (US)

Correspondence Address: BRACEWELL & GIULIANI LLP, P.O. BOX 61389, HOUSTON, TX, 77208-1389, US

(73) Assignee: Exopack-Technology, LLC, Spartanburg (US)

(21) Appl. No.: 11/285,698

(22) Filed: Nov. 22, 2005

Related U.S. Application Data
(60) Provisional application No. 60/682,898, filed on May 20, 2005.

(51) Int. Cl. H05B 6/80

(52) U.S. Cl. 219/730

(57) ABSTRACT

A microwave cooking package and combination of a food product and microwave cooking package. The cooking package intimately contacts and substantially surrounds the food product as the food product is cooked in a microwave oven. The package provides for venting of moisture in specific regions of the food product and distribution of heat across the extent of the food product to facilitate cooking of the entire food product and more uniform browning and crisping of the outer surface of the food product. The cooking package is preferably used for cooking a dough enclosed food product in a microwave oven. The package of the present invention allows the food product to be uniformly cooked to a golden brown color with a crispy, crunchy consistency.

### RELATED APPLICATIONS

This application is a continuation of U.S. Application Serial No. ______ filed Nov. 21, 2005, titled “Microwave Cooking Package for Food Products and Associated Methods,” which claims priority to U.S. Provisional Patent Application Ser. No. 60/682,898, filed on May 20, 2005.

### BACKGROUND OF THE INVENTION

1. Field of the Invention

The present invention relates to microwave cooking packaging for food products. More specifically, the present invention is directed to multilayer packaging for use in cooking dough enclosed food products in a microwave oven and associated methods of forming and using same.

2. Description of Related Art

Microwave ovens are commonly used for quick and convenient heating and cooking of food products. Microwave heating and cooking involves the transmission of microwave energy into the food product, whereby the microwave energy penetrates into the interior portion of the food product. As the microwave energy heats the interior portion of the food product, moisture from within the food product migrates to the surface of the food product.

It is not uncommon for the migrating moisture to collect on the exterior surface of the food product. The temperature of the exterior surface is typically not high enough to evaporate this moisture away from the surface, as would be the case in, for example, conventional convection ovens. As a result, many food products cooked in microwave ovens are wet or soggy on the outside, but dry and warmed on the inside. This problem is particularly noticeable for dough enclosed and other similar food products.

As a result, the prior art sought to develop devices and methods for removing moisture from the exterior surface of food products during microwave cooking. Certain devices utilized tubular or hollow cooking packages that surrounded the food product. These devices typically contained metallic susceptors that contacted some or all of the outer surface area of the food product. The susceptors absorbed microwave energy and became heated, and the resultant heat was used to cook the food.

Unfortunately, these devices did not provide adequate means for venting the moisture on the food surface. The venting means that were available were not positioned adjacent to the areas of the food product that contained or emitted the most moisture, or were not sized appropriately. As a result, moisture removal was inefficient, and the exterior surfaces of the food products cooked with these devices remained relatively soggy.

The prior art also sought to develop devices and methods for uniformly cooking the outer surface of microwaved food products. Many of these previously developed methods and devices included the use of susceptor materials to heat the food product. These susceptor materials, however, were often times positioned adjacent to or near only certain sides or sections of the food product, such that the susceptors only intimately contacted or delivered heat directly to certain sections of the food product, thus resulting in uneven cooking of the food product. For example, these susceptor materials would overcook only the respective ends of a given food product, or undercook only the medial region of the food product.

Also, certain devices were in the form of packaging materials which utilized susceptors that constituted a single or continuous layer in the structure of the packaging material, and exhibited a generally uniform heat conductance capacity along the entire extent of, or substantial regions of, the food item, whereby certain areas or sections of the particular food item that required, for example, greater microwave reflection capacity or less microwave cooking energy, would be overcooked or burned. Further, certain of these susceptor containing devices were in the form of boxes or other similar shapes, whereby, for example, in certain areas of the box, the susceptors were positioned closely to the food product, while in other areas of the box, for example the corners, the susceptors were distant from the food product. This resulted in uneven heating and cooking of the food product. Further, these prior devices often utilized a closure substance or mechanism, such as, for example, glue or other adhesives, at or near the ends of the device to allow a user to enclose the food product within the device. This adhesive material could contaminate the food product. Further, the adhesive could lose its sticking and adhesive capacity during cooking and disrupt the cooking process, resulting in an unevenly cooked food product.

Therefore, a need exists for a microwave cooking package that allows for sufficient venting of the moisture on the food surface. Further, a need exists for a package that is open ended and yet allows for venting in the areas of the package adjacent to the sections of the food product containing or emitting the most moisture. There also is a continued need for a microwave cooking package that uniformly cooks the outer surface of microwaved food products, in particular dough enclosed food products and the like, to a golden brown color with a crispy, crunchy consistency, if desired, without overcooking or drying out all of, or certain regions of, the food product or the dough.

### SUMMARY OF THE INVENTION

In view of the foregoing, embodiments of the present invention advantageously provide a microwave cooking package that intimately contacts and substantially surrounds a food product as the food product is cooked in a microwave oven.

More specifically, an embodiment of the present invention provides a combination dough enclosed food product and microwave cooking package that preferably includes a package having a first layer of paper, a second layer of microwave susceptor material, and a third outermost layer of paper. The package is adapted to intimately contact and substantially surround the food product when the food product is cooked in a microwave oven. The first, second and third layers are positioned so that the second layer of microwave susceptor material lies between the first and third layers of paper and defines a second inner layer. The second inner layer of microwave susceptor material preferably includes a plurality of susceptor zones, wherein at least one susceptor zone is adapted to reflect microwave energy away from a respective adjacent region of the food product in an amount sufficient to prevent overcooking of said region of the food product when the combination food product and microwave cooking package is heated by the application of microwaves in the microwave oven. At least one other susceptor zone is adapted to substantially conduct and absorb microwave energy in order to provide heat for cooking at least a respective adjacent other region of the food product.

The microwave cooking package is preferably in the form of a tubular sleeve having at least one open end, wherein the food product is inserted into the open end of the sleeve. Preferably, the food product is a cylindrically shaped item such as, for example, an egg roll, such that the cylindrical food product will intimately contact and be substantially surrounded by the tubular sleeve to a large extent. Non-cylindrically shaped food items, however, are also encompassed with the scope of the food products of the present invention, so long as the cooking package generally surrounds the food product. In an embodiment, the package is substantially open ended when a food product is cooked in the package in a microwave oven. The package preferably has a plurality of venting apertures formed in its first, second and third layers to allow moisture on an outer surface of the food product to escape from the package during heating in a microwave oven.

The food product can have a first region adjacent to a first susceptor zone of the cooking package, a second medial region adjacent to a second medial susceptor zone of the cooking package, and a third region adjacent to a third susceptor zone. The second medial susceptor zone is positioned between the first and third susceptor zones. The first and third susceptor zones are more highly reflective than the second susceptor zone to prevent overcooking of the first and third regions of the food product. The venting apertures can be formed in the section of the package adjacent to the second medial susceptor zone to allow moisture to escape from the package at a location near the second medial region of the food product, thus provides for uniform browning and crisping along the extent of the outer surface of the food product. The venting apertures can be formed in, and penetrate completely through, the first, second and third layers of the paper material as well as the susceptor material. Each susceptor zone can have an optical density sufficient to prevent overcooking of the region of the food product adjacent to the respective susceptor zone. The first and third susceptor zones can have optical densities in the range of 0.38 to 0.42 and the second medial susceptor zone can have an optical density in the range of 0.15 to 0.20. The first and third susceptor zones can each have optical densities in the range of 20% to 200% higher than the optical density of the second medial susceptor zone.

Embodiments of the present invention also advantageously provide a combination dough enclosed food product, microwave cooking package and packaging film wherein the microwave cooking package intimately contacts and substantially surrounds the food product as the food product is cooked in a microwave. The package includes at least one layer of microwave susceptor material having a plurality of susceptor zones therein, the susceptor zones positioned adjacent to regions of the food product during cooking. At least one susceptor zone reflects microwaves away from a respective adjacent region of the food product in an amount sufficient to prevent overcooking of said region of the food product. At least one other susceptor zone is adapted to substantially conduct and absorb microwave energy in order to provide heat for cooking at least a respective adjacent other region of the food product. A packaging film, such as, for example shrink wrap, substantially surrounds the food product and microwave cooking package to secure the food product and cooking package therewithin. The packaging material prevents sliding or misplacement of the food product and packaging material, as well protects the food product from dirt and other debris. The microwave cooking package can be compressed upon being secured within the packaging materials to conserve space and for ease of storage or transport. The packing material is preferably removed from the food product and cooking package before the food product and cooking package are placed in a microwave oven to prevent burning or melting of the packaging material.

At least two of the susceptor zones in the susceptor material can have different optical densities to provide different amounts of conductance and absorbance of microwave energy for cooking respective adjacent regions of the food product when the food product is substantially surrounded by the microwave cooking package and heated by the application of microwaves in a microwave oven.

Another embodiment of the present invention provides a microwave cooking package having a first layer of packaging material, a second layer of microwave susceptor material, and a third layer of packaging material. The packaging material can be, for example, paper or a heat resistant and dimensionally stable polymeric material. The first, second and third layers are positioned so that the second layer of microwave susceptor material lies between the first and third outermost layers of packaging material to define an inner layer. The first, second and third layers are formed into a tubular sleeve that substantially surrounds and intimately contacts a frozen food product positioned within the interior of the sleeve prior to heat being applied in the microwave oven. The tubular sleeve has a plurality of venting apertures formed therein to allow moisture on an outer surface of the food product to escape from the package during cooking. The inner layer of microwave susceptor material includes a plurality of susceptor zones positioned along the longitudinal extent of the cooking package and aligned adjacent to selected regions of the food product during cooking, whereby each susceptor zone reflect microwaves away from a respective adjacent region of the food product to some extent in an amount sufficient to prevent overcooking of said region of the food product.

The present invention also advantageously provides a microwave cooking package that has at least one layer of microwave susceptor material that substantially surrounds a food product as the food product is cooked in a microwave. The package may be formed into a tubular sleeve or any other shape that substantially surrounds and intimately contacts a frozen food product positioned within the interior of the package as the food product is cooked. The susceptor material has a plurality of susceptor zones positioned along the longitudinal extent thereof, wherein each susceptor zone is aligned adjacent to a selected region of the food product during cooking. At least one susceptor zone reflects microwaves away from the respective adjacent region of the food product in an amount sufficient to prevent overcooking of said region of the food product. At least one other susceptor zone is adapted to substantially conduct and absorb microwave energy in order to provide heat for cooking at least a respective adjacent other region of the food product. The tubular sleeve may have a plurality of venting apertures formed along the circumferential extent thereof to allow moisture on an outer surface of the food product to escape from the package during cooking. In an embodiment, the venting apertures are formed in the region of the packaging material having the susceptor zone that substantially conducts and absorbs microwave energy to provide a location for release of moisture from the respective adjacent other region of the food product.

The present invention also provides a microwave cooking package having a plurality of susceptor zones, each susceptor zone containing at least one layer of microwave susceptor material. At least two of the susceptor zones can have different optical densities such that the susceptor zones provide different amounts of conductance and absorbance of microwave energy for cooking respective adjacent regions of the food product when the food product is substantially surrounded by the microwave cooking package and heated by the application of microwaves in the microwave oven.

The present invention also provides a cooking package for cooking selected regions of a food product in a microwave oven. The cooking package can include a packaging material with a plurality of susceptor zones positioned along the extent thereof, each susceptor zone being adapted for alignment adjacent to a selected region of the food product when the food product is positioned inside the cooking package. Each susceptor zone contains one or more microwave susceptor materials with a capacity for conducting and absorbing microwave energy, such that the susceptor materials in the respective susceptor zones provide the respective amounts of heat needed for cooking the respective selected adjacent regions of the food product.

The packaging material can be adaptable to form a sleeve that substantially surrounds and intimately contacts the food product as the food product is cooked in a microwave oven. The sleeve can be tubular and can have a medial region and a pair of end regions. A plurality of venting apertures can be formed along the circumferential extent of the medial region of the sleeve to allow moisture from the adjacent medial region of the food product to escape from the package during cooking. The packaging material can initially be substantially open ended such that the food product can be inserted into the package prior to cooking. The package can also remain substantially open ended during the cooking process, which allows for venting of moisture from the respective end regions of the food product.

In addition to the microwave cooking package and combination cooking package and food product, the present invention also advantageously provides methods of forming a microwave cooking package for cooking a frozen food product. A method of forming a microwave cooking package includes positioning a first layer of packaging material, a second layer of microwave susceptor material, and a third layer of packaging material so that the first and third layers of paper are the outermost layers of a package. A plurality of venting apertures is formed in the package. The package is formed or shaped into a tubular sleeve that intimately contacts and substantially surrounds the food product when the food product is cooked in a microwave such that moisture on the outer surface of the food product is expelled from the sleeve through the venting apertures.

In an embodiment of the invention, a method of forming a microwave cooking package for cooking a food product includes forming a plurality of venting apertures in a packaging material, shaping the packaging material into a sleeve and shaping the food product to be intimately contacted and substantially surrounded by the sleeve such that when the food product is cooked in a microwave oven, the moisture on the outer surface of the food product is expelled from the sleeve through the venting apertures.

Another embodiment of the present invention also provides a method of forming a microwave cooking package for cooking a food product which includes positioning a first layer of paper, a second layer of microwave susceptor material, and a third layer of paper so that the first and third layers of paper are the outermost layers of a packaging material, forming a plurality of venting apertures in the packaging material and shaping the packaging material into a tubular sleeve that intimately contacts and substantially surrounds the food product when the food product is cooked in a microwave such that moisture on the outer surface of the food product is expelled from the sleeve through the venting apertures.

The present invention also advantageously provides a method of using a microwave cooking package for cooking a frozen food product. A method of using a microwave cooking package preferably includes forming or shaping a packaging material into a tubular sleeve that intimately contacts and substantially surrounds a food product when the food product is cooked in a microwave. In an embodiment, the food product can likewise be shaped to intimately contact and be substantially surrounded by the packaging material. Preferably, moisture on the outer surface of the food product is expelled from the sleeve through venting apertures formed in the sleeve. Alternatively, the method can involve inserting the food product into a pre-formed tubular sleeve as opposed to a user forming the sleeve himself.

### BRIEF DESCRIPTION OF THE DRAWINGS

Some of the objects and advantages of the present invention having been stated, others will become apparent as the description proceeds when taken in conjunction with the accompanying drawings, in which:

FIG. 1 is a top view of a packaging material for forming a microwave cooking package in accordance with an embodiment of the present invention;

FIG. 2 is a fragmentary sectional view of the packaging material of FIG. 1 taken along the line W in accordance with an embodiment of the present invention;

FIG. 3 is the fragmentary sectional view shown in FIG. 2 separated into disconnected susceptor zones in accordance with an embodiment of the present invention

FIG. 4 is a perspective view of the multiple layers of a packaging material in accordance with an embodiment of the present invention;

FIG. 5 is a perspective view of a packaging material being formed into a tubular microwave cooking package in accordance with an embodiment of the present invention;

FIG. 6A is a perspective view of a tubular microwave cooking package with at least two ends of the package contacting each other in accordance with an embodiment of the present invention;

FIG. 6B is a perspective view of a tubular microwave cooking package with at least two ends of the package contacting each other in accordance with an embodiment of the present invention;

FIG. 7 is a perspective view of a food product being inserted into microwave cooking package in accordance with an embodiment of the present invention;

FIG. 8 is a side view of a microwave cooking package containing a food product in accordance with an embodiment of the present invention;

FIG. 9 is a perspective view of a microwave cooking package and food product in accordance with an embodiment of the present invention;

FIG. 10 is a perspective view of a microwave cooking package and food product in accordance with an embodiment of the present invention;

FIG. 11 is a perspective view of a microwave cooking package and food product in accordance with an embodiment of the present invention;

FIG. 12 is a perspective view of a microwave cooking package and food product in accordance with an embodiment of the present invention;

FIG. 13 is a perspective view of a combination compressed microwave cooking package, food product and packaging film in accordance with an embodiment of the present invention;

FIG. 14 is a perspective view of a combination expanded microwave cooking package, food product and packaging film in accordance with an embodiment of the present invention;

FIG. 15 is a perspective view of a microwave cooking package expanded to enclose a food product in accordance with an embodiment of the present invention;

FIG. 16 is a perspective view of a microwave cooking package and food product being inserted into a microwave oven in accordance with an embodiment of the present invention; and

FIG. 17 is a perspective view of microwaves interacting with a combination microwave cooking package and food product in a microwave oven in accordance with an embodiment of the present invention.

### DETAILED DESCRIPTION

The present invention now will be described more fully hereinafter with reference to the accompanying drawings in which illustrated embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout, and prime notation, if used, indicates similar elements in alternative embodiments.

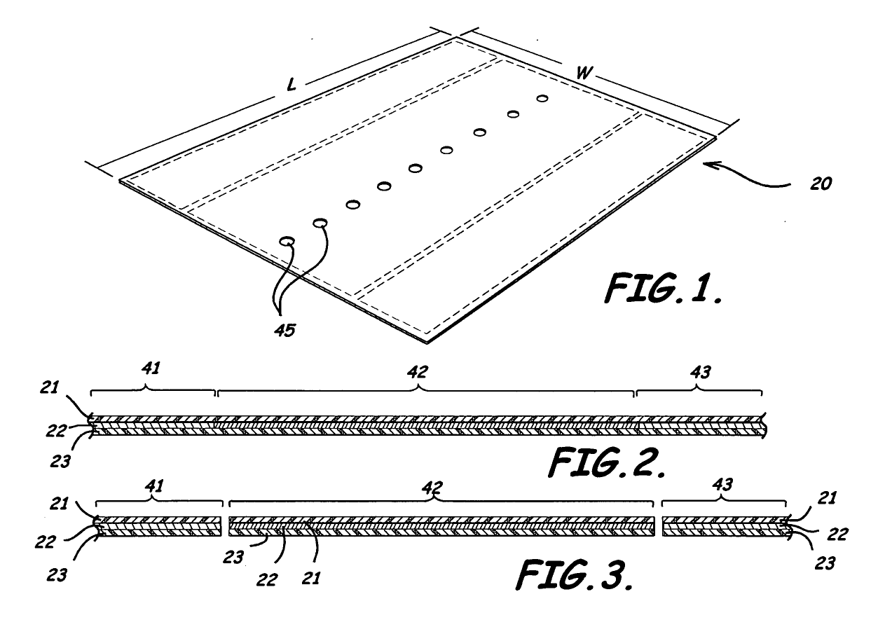

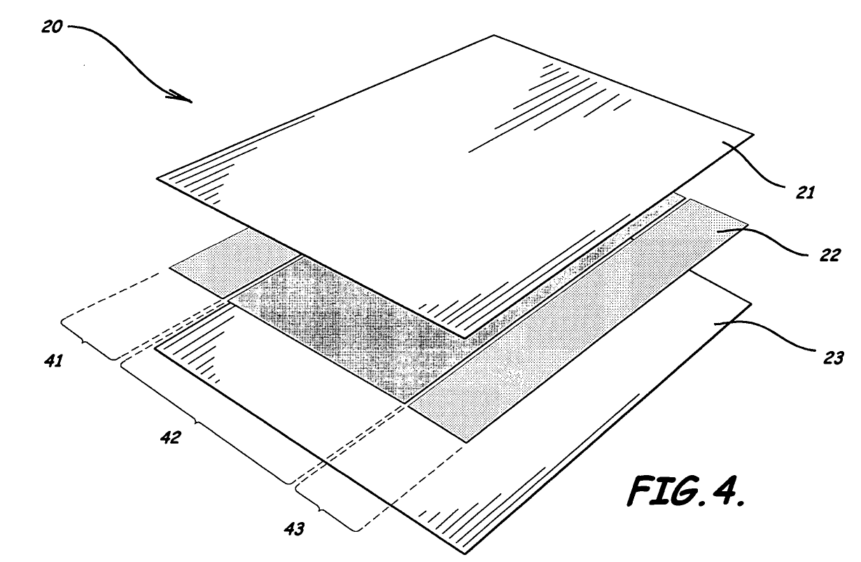

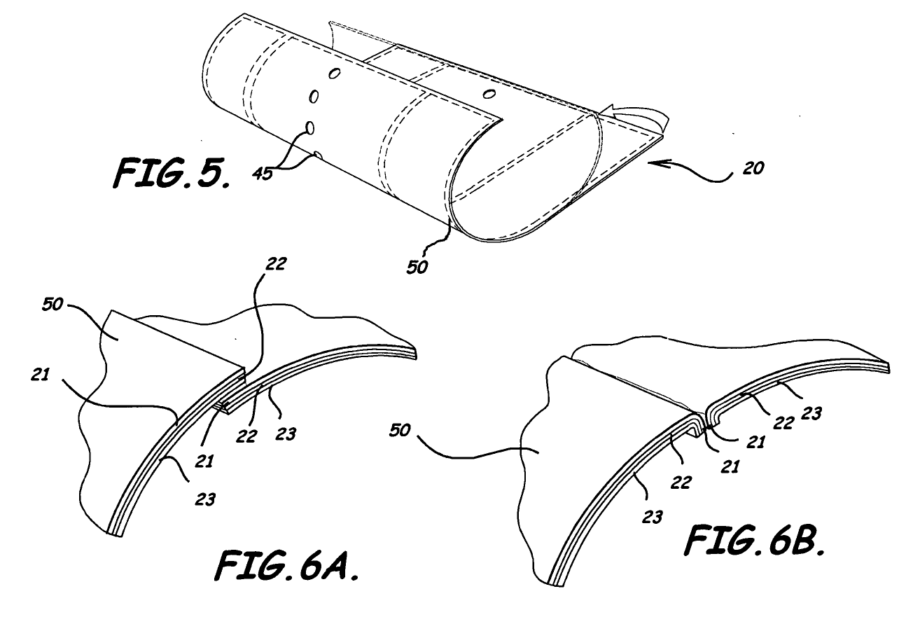

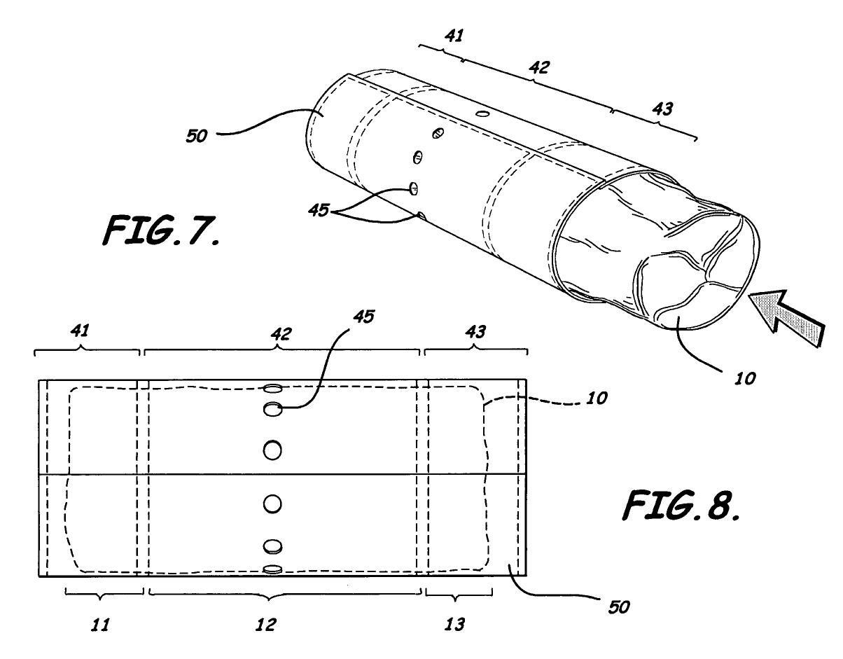

As illustrated in FIGS. 1-17 herein, embodiments of the present invention advantageously provide a microwave cooking package 10 and combination of a food product 10 and microwave cooking package 20. The cooking package 20 intimately contacts and substantially surrounds the food product 10 as the food product 10 is cooked in a microwave. The package 20 provides for venting of moisture and distribution of heat across the extent of the food product 10 to facilitate cooking of the entire food product 10 and uniform browning and crisping of the outer surface of the food product 10. The cooking package 20 is preferably used for cooking a dough enclosed food product 10, such as a frozen egg roll, in a microwave oven. The package 20 of the present invention allows the food product 10 to be uniformly cooked to a golden brown color with a crispy, crunchy consistency. Other similar dough enclosed food products 10 besides egg rolls such as, for example, burritos, pizza rolls, hot pockets, cheese sticks or soft shell tacos, can also be cooked using the package 20 of the present invention. Further, the term dough generally refers to flour, wheat, corn, oats, bread crumbs or other similar starch-based ground grain mixtures, and the phrase dough enclosed food product generally refers to a food product that is enrobed, enclosed or substantially or partially surrounded by, wrapped, coated or breaded with a dough comprising a flour, wheat, corn, oats, bread crumbs or other like starch-based ground grain mixture. Non-dough enclosed food products 10, such as, for example, buffalo wings or french fries, are also advantageously included in the combination food product 10 and microwave cooking package 20 of the present invention.

The package 20 preferably has a first paper layer 21, a second inner layer 22 of microwave susceptor material 22, and a third paper layer 23. Other packaging materials besides paper, such as, for example, a heat resistant and dimensionally stable polymeric material, can also be utilized in the first and third layers. The paper layers 21, 23 and susceptor layer 22 can have printing or no printing thereupon, as desired. The susceptor material 22 is typically formed of aluminum or another similar metallized or other material having desired susceptor properties. The first 21, second 22 and third 23 layers are positioned so that the inner layer of microwave susceptor material 22 lies between the first 21 and third 23 layers of paper. Preferably, the package 20, when laid flat as illustrated in FIG. 1, is approximately 8 inches wide and 5 inches long, although the length, width and dimensions of the package 20 will vary depending upon, for example, the size, shape and type of food item 10 that will be cooked in the package 20.

In other embodiments, the package 20 includes at least one layer of microwave susceptor material 22, and other layers positioned adjacent to, or on top or bottom of, the susceptor material 22 as desired. The additional layers can comprise paper or other materials, or can comprise additional susceptor layers. Typically, by stacking multiple layers of susceptor material such that the layers intimately contact one another, the reflective properties of the susceptor materials are increased. Similarly, separate individual susceptors having different optical densities, or a single susceptor having varying optical densities thereupon, can also be utilized to achieve the desired amount of susceptor activity. The phrase “optical density,” as understood by those skilled in the art, refers to the negative logarithm of the reflectance of the susceptor material. For example, a susceptor material that reflects 10% percent of incident microwave energy has an optical density of −log (0.10)=1.00. Generally, if one or more paper layers are positioned between layers of susceptor material, as encompassed in embodiments of the present invention, the heating properties of the susceptor materials are increased. As illustrated in FIGS. 2 and 3, each of the paper layers 21 and 23 can be a single unitary sheet of paper, or alternatively, the layers 21, 23 can be formed of multiple sheets that are glued or otherwise affixed together.

The second inner layer of microwave susceptor material 22 preferably includes a plurality of susceptor zones 40. The plurality of susceptor zones 40 preferably includes a first susceptor zone 41, a second medial susceptor zone 42, and a third susceptor zone 43, although any number of zones 40 may be utilized without departing from the scope of the present invention. One or more of the susceptor zones 41, 42, 43 may be glued or otherwise affixed together, or alternatively, positioned adjacent to one another yet disconnected and spaced apart. The susceptor zones 40 function to reflect microwaves when the package 20 is in use in order to prevent overcooking of the food product 10 in the region of the product 10 covered by the susceptor material 22.

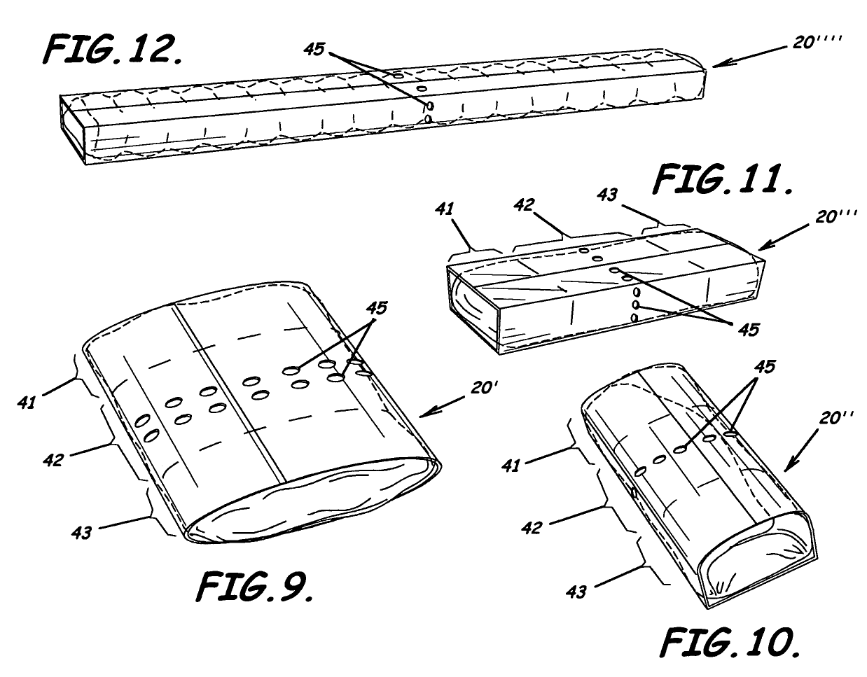

The amount of reflection provided by the susceptor material 22 is generally measured by the optical density of the material 22. As understood by those skilled in the art, the higher the optical density, the greater the tendency for the susceptor material 22 to reflect more microwaves and to allow fewer microwaves to pass through the susceptor material 22 to the food product 10. The lower the optical density, the greater the tendency for a larger percentage of microwaves to be absorbed by, or penetrate or pass through, the susceptor material 22, which results in increased heat energy that heats or cooks the food product 10. Preferably, each susceptor zone 40 has an optical density sufficient to prevent overcooking of the region of the food product 10 adjacent to said susceptor zone 40. Preferably, the package 20 is shaped and the specific susceptor zones 40 are each positioned such that different levels of browning and cooking of respective adjacent regions of a particular type of food product 10 are achieved in a microwave oven. As illustrated, for example, in FIGS. 9-12, the package 20 can be sized and shaped to substantially enclose and/or intimately contact food products 10 of various dimensions and shapes. Similarly, the size, shape and/or dimensions of the food product 10 can be adjusted such that a particular package 20 will substantially enclose and/or intimately contact the regions of the food product 10 to achieve desired cooking results.

The susceptor zones 40 are generally aligned such that those with higher optical densities are positioned at, near, adjacent to or covering areas of the food product 10 that require additional protection such as, for example, the ends of an dough enclosed food product 10 that contain more dough than filling. These areas of the dough enclosed food product 10 have more dough in order to prevent the filling from leaking out from the food product 10. The added dough in these regions makes these regions of the food product 10 more likely to dry out and become overcooked or burned when cooked with microwave energy. The filled region of the product 10, in contrast, is more likely to cook to a desired crispness and consistency when cooked with the same microwave energy. Positioning the susceptor zones 40 in the package 20 with higher optical densities and higher reflective properties in locations at, adjacent to, near or covering the area of the food product 10 needing additional protection allows for more reflection and less conduction of microwave energy in these vulnerable regions, which reduces the tendency for burning or overcooking in these regions and results in a more uniformly cooked food product 10.

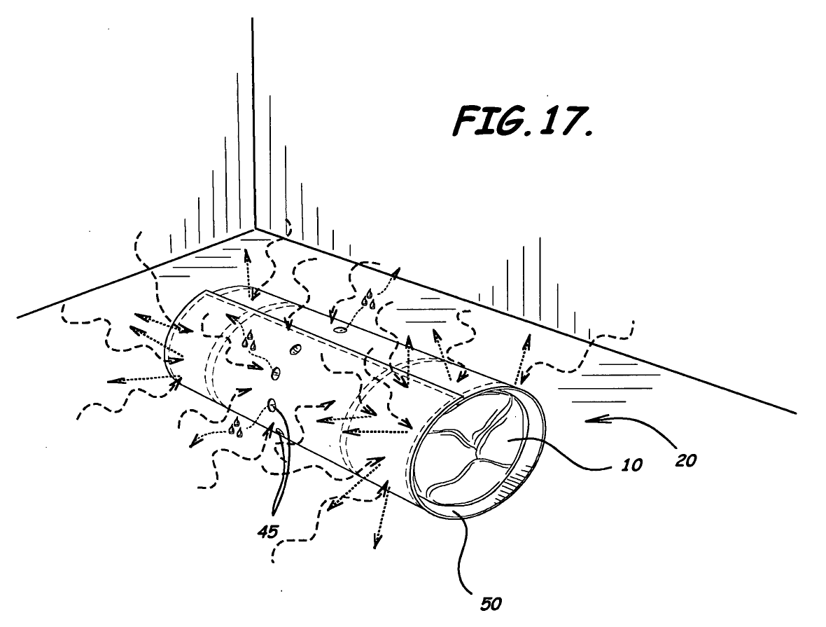

In an embodiment of the present invention, the first, second and third susceptor zones 41, 42, 43 are generally aligned so that the second medial susceptor zone 42 is positioned between the first and third susceptor zones 41, 43. Each susceptor zone 40 is designed to allow for uniform fine cooking, crisping and browning of the particular region of the food product 10 to which it is adjacent, depending upon the properties of the particular region of the food product 10. At least one susceptor zone 40 reflects microwaves away from a respective adjacent region of the food product 10 in an amount sufficient to prevent overcooking of said region of the food product 10. At least one other susceptor zone 40 allows microwaves to penetrate and cook another respective adjacent region of the food product 10 in an amount sufficient to properly cook said other region of the food product 10. As illustrated in FIG. 17, the package 20 containing the food product 10 can remain substantially open ended, if desired, as the food product 10 is cooked in the microwave oven to allow venting of moisture from end regions of the food product 10.

As understood by those skilled in the art, the optical density of the susceptor material is equal to the negative logarithm of the reflectance of the susceptor material. In an embodiment utilized to cook a frozen egg roll in a microwave oven to a desired brownness and crispness, the first and third susceptor zones 41, 43 have an optical density in the range of 0.34 to 0.50, more preferably 0.38 to 0.42, and the second medial susceptor zone 42 has an optical density in the range of 0.15 to 0.24, more preferably 0.15 to 0.20. As mentioned previously, however, the various susceptor zones 40 can each have optical densities that are necessary or desired in order to prevent overcooking of certain regions of the food product 10 and facilitate the desired level of cooking of other certain regions of the food product 10.

A ratio representing the optical densities of respective susceptor zones 40 of the food package can also be used to measure cooking effectiveness. For example, the optical density ratio can be determined by dividing a numerator value by a denominator value. The optical density for the second medial susceptor zone 42 defines the denominator value for the ratio, and the optical densities for the first and/or third susceptor zones 41, 43 define the numerator value for the ratio. In an embodiment in which a frozen egg roll is cooked using the package 10 of the present invention, the ratio of the optical densities for the cooking package 10 is in the range from 1.2 to 3.0, and more preferably from 1.5 to 2.5. The susceptor zones 40 adjacent to the areas of the food product 10 requiring the highest protection can have optical densities that are about 20% to 200% higher than those susceptor zones 40 adjacent to area of the food product 10 requiring lower protection.

According to the present invention, the food product 10 may have a first region 11 adjacent to a first susceptor zone 41 of the cooking package 20, a second medial region 12 adjacent to a second medial susceptor zone 42 of the cooking package 20, and a third region 13 adjacent to a third susceptor zone 43. Typically, the first and third susceptor zones 41, 43 are more highly reflective than, and provide different amounts of conductance and absorbance of microwave energy than, the second susceptor zone 42 to prevent burning of the respective ends of the egg roll or other food product 10.

The microwave cooking package 20 of an embodiment of the invention preferably has a plurality of venting apertures 45 formed therein to allow moisture formed on an outer surface of, or emanating from within, the food product 10 to migrate from the food product 10 and escape from the package 20 during cooking. In a preferred embodiment, 8-10 venting apertures are formed in the package 20, although any number of apertures 45 necessary to remove moisture may be utilized. The venting apertures 45 are preferably formed in the section of the microwave cooking package 20 adjacent to the region of the food product 10 requiring the most heating. In an embodiment of the invention for cooking egg rolls, the venting apertures 45 are formed in the second medial susceptor zone 42 of the package 20, because the second medial susceptor zone 42 is adjacent to the medial region 12 of the egg roll. The largest amount of moisture will typically emanate from this thicker or non-doughy medial section 12 of the egg roll during cooking in a microwave oven, due to the shape and areas of moisture concentration in the egg roll and due to first and third susceptor zones 41, 43 being more highly reflective than the second susceptor zone 42 and reflecting microwaves away from the ends of the egg roll adjacent to first and third susceptor zones 41, 43; however, the venting apertures 45 can be placed in any desired location along the longitudinal extent of the cooking package 20 to facilitate the desired venting. The venting apertures 45 can be positioned in a single row or multiple rows relative to one another. Also, the apertures 45 can be circular in shape, or can have other shapes as desired, and can be sized, or spaced apart from one another, as desired in order to facilitate the desired amount of venting from either frozen or non-frozen food products 10. The combined area of the venting apertures 45 can be dependent upon the moisture content of the food product 10 and the amount of venting necessary for satisfactory cooking of the food product 10. Preferably, the combined area of the venting apertures 45 does not exceed 20% of the total surface area of the package 20.

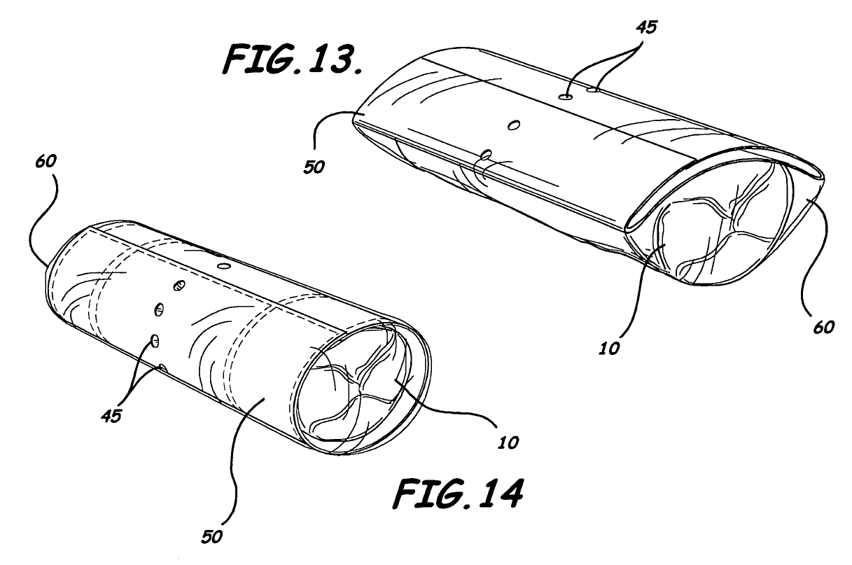

In another embodiment, the present invention also advantageously provides a combination dough enclosed food product 10, microwave cooking package 20 and packaging film 60. The packaging film 60 preferably substantially surrounds both the food product 10 and microwave cooking package 20 to secure the food product 10 and cooking package 20 therewithin, as illustrated in FIGS. 13 and 14. For example, a flour-covered frozen egg roll 10 and cooking package 20 can be provided in an outer shipping package formed of a flexible or shrink-wrap plastic film wrapping material 60.

A consumer would first open the packaging film 60 and then remove the food product 10 and the cooking package 20. Preferably, the cooking package 20 comprises a tubular sleeve 50, and the sleeve 50 is compressed when secured within the packaging film 60 to minimize the amount of required storage space for the combination. The consumer would then remove the food product 10 and tubular sleeve 50 from the packaging film 60, expand the tubular sleeve 50 and slip the food product 10 into the sleeve 50. The consumer would then place the food product 10 and sleeve 50 in the microwave. After the food product 10 is cooked, the consumer should at least partially remove the sleeve 50 from the product 10 to eat the product 10. In a preferred embodiment, the surface of the sleeve 50 that contacts the food product 10, for example, can be coated with, or be formed of, a nonstick material to facilitate the removal of the cooked food product 10 from the package 20. In another embodiment, the sleeve 50 is not compressed, and the food product 10 is located inside of the sleeve 50 while the food product 10 and sleeve 50 are both covered by the packaging film 60.

In an embodiment of the present invention, a microwave cooking package 20 has a first layer of paper 21, a second layer of microwave susceptor material 22, and a third innermost layer of paper 23. The first, second and third layers 21, 22, 23 are positioned so that the second layer of microwave susceptor material 22 lies between the first and third layers of paper 21, 23 and defines a second inner layer 22, the second inner layer 22 having a plurality of susceptor zones 40, the susceptor zones 40 including a first susceptor zone 41, a second medial susceptor zone 42, and a third susceptor zone 43. The first, second and third susceptor zones 41, 42, 43 are aligned so that the second medial susceptor zone 42 is positioned between the first and third susceptor zones 41, 43. The second zone 42 can contact the first zone 41 and/or the third zone 43, or the second zone 42 can be detached from and not contact the first and third zones 41, 43, such as, for example, in the case where the zones 41, 42, 43 are positioned apart from one another at a distance necessary to produce distinctly different levels of heating for different regions of a food product 10.

The package 20 has a plurality of venting apertures 45 formed in the first, second and third layers 21, 22, and 23. The apertures can be exclusive to the second medial susceptor zone 42 or adjacent to any or all susceptor zones 40. The susceptor zones 40 can be positioned along the longitudinal extent of the cooking package 20 and aligned adjacent to selected regions of the food product 10 during heating in a microwave oven. Each susceptor zone 40 reflects microwaves away from a respective adjacent region of the food product 10 in an amount sufficient to prevent overcooking of said region of the food product 10.

The food product preferably has a first region 11 adjacent to the first susceptor zone 41 of the cooking package 20, a second medial region 12 adjacent to the second medial susceptor zone 42 of the cooking package 20, and a third region 13 adjacent to the third susceptor zone 43. The first and third susceptor zones 41, 43 are more highly reflective than the second susceptor zone 42 to prevent overcooking of the first and third regions 11, 13 of the food product 10.

The present invention also advantageously provides a microwave cooking package 20 having at least one layer of microwave susceptor material 22 that substantially surrounds a food product 10 as the food product 10 is cooked in a microwave. The layer of microwave susceptor material 22 has a plurality of venting apertures 45 formed therein to allow moisture on an outer surface of the food product 10 to escape from the package 20 during cooking. The susceptor material 22 has a plurality of susceptor zones 40 positioned along the longitudinal extent thereof, wherein each susceptor zone 41, 42, and 43 is aligned adjacent to a selected region 11, 12, 13 of the food product 10 during cooking. Each susceptor zone 41, 42, 43 reflects microwaves away from the respective adjacent region 11, 12, 13 of the food product 10 in an amount sufficient to prevent overcooking of said region of the food product 10. Each susceptor zone 41, 42, 43 can also have an optical density sufficient to prevent overcooking of the respective adjacent regions of the food product 10.

A combination frozen food product 10 and microwave cooking package 20 is also provided according to an embodiment of the present invention. The microwave cooking package 20 intimately contacts the food product 10 as the food product 10 is cooked in a microwave. The package 20 including at least one layer of microwave susceptor material 22 that substantially surround the food product 10. The layer of microwave susceptor material 22 includes a plurality of susceptor zones 40 positioned along the longitudinal extent of the cooking package 20 and aligned adjacent to selected regions of the food product 10 during cooking. Each susceptor zone 40 reflects microwaves away from a respective adjacent region of the food product 10 in amounts sufficient to prevent overcooking of said region of the food product 10. In one embodiment, as illustrated in FIG. 3, the food product 10 has a first region 11 adjacent to a first susceptor zone 41 of the cooking package, a second medial region 42 adjacent to a second medial susceptor zone 42 of the cooking package 10, and a third region 13 adjacent to the third susceptor zone 43. The first and third susceptor zones 41, 43 are more highly reflective than the second susceptor zone 42 to prevent overcooking of the first and third outermost regions 11, 13 of the food product.

In another embodiment, the microwave cooking package 20 advantageously includes at least one layer of microwave susceptor material 22, among other various combinations of layers, wherein the package 20 is formed into a tubular sleeve 50 that substantially surrounds and intimately contacts a frozen food product 10 positioned within the interior of the sleeve 50. The tubular sleeve 50 has a plurality of venting apertures 45 formed along the circumferential extent thereof to allow moisture on an outer surface of the food product 10 to escape from the package during cooking.

As shown in FIGS. 1-17, the present invention also advantageously provides a method of forming a microwave cooking package 20 for cooking a frozen food product 10. The method includes positioning a first layer of paper 21, a second layer of microwave susceptor material 22, and a third layer of paper 23 so that the first and third layers of paper 21, 23 are the outermost and innermost layers, respectively, of a packaging material 20. Other packaging materials besides paper, such as, for example, a heat resistant and dimensionally stable polymeric material, can also be utilized in the first and third layers 21, 23. A plurality of venting apertures 45 are formed in the packaging material 20. The packaging material 20 is shaped into a tubular sleeve 50 that intimately contacts and substantially surrounds the food product 10 when the food product 10 is cooked in a microwave. Preferably, the food item 10 will be, at most, approximately 0.25 inches from the sleeve 50, in order for sufficient intimate contact and substantial conductive heat transfer to the food product 10 to occur, and to provide for sufficient, uniform browning and crisping of the outer surface of the food product 10. Other distances between the food product 10 and the sleeve 50 can be utilized, depending upon factors including but not limited to the size and type of food product 10 and the size of the sleeve 50. If desired, the food product 10 can physically contact the interior of the sleeve 50 to achieve an additional desired amount of browning and crisping of a particular region of the food product 10. Such direct physical contact can be between the susceptor material and the food product 10 or between a layer of the package 20 and the food product 10.

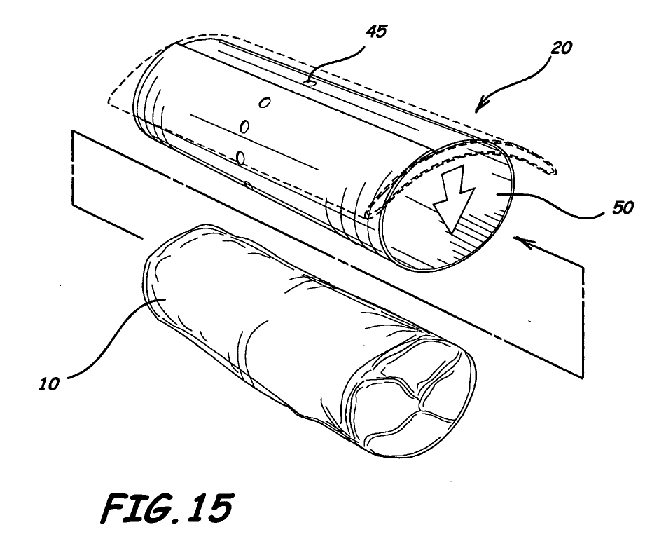

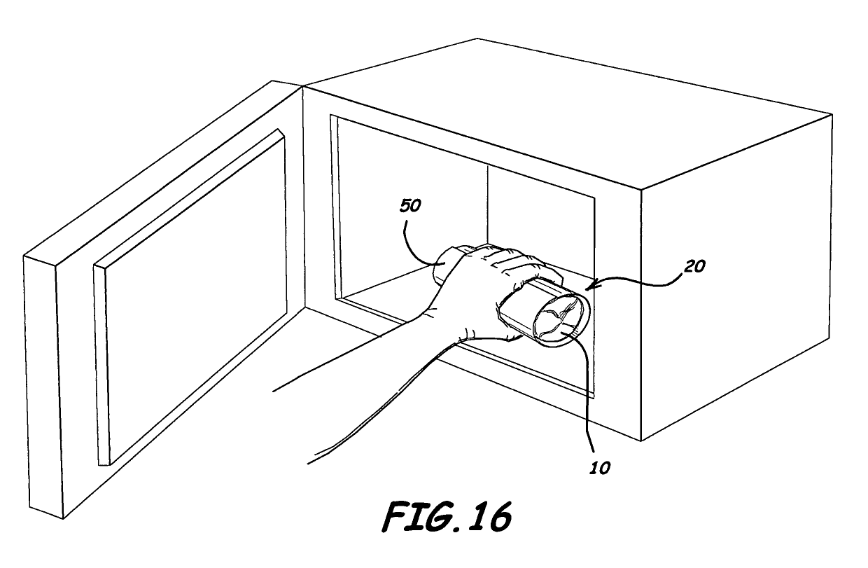

In an embodiment of the invention, the package 20 is open ended such that a food product 10 can be inserted into the package 10, as shown, for example, in FIG. 15, and the package can remain open ended during cooking of the food product 10 without the need for adhesive to close the package ends. During cooking, one or more of the respective ends of the package 20 can protrude past the ends of the food product 10. In contrast, one or more of the ends of the food product 10 can protrude out of the ends of the package 20. Preferably, both of the respective ends of the package 20 will protrude at least 2-3 inches past the ends of the food product 10 to achieve crisping and browning along the entire extent of the food product 10.

As a result of the package 20 being open ended, some amount of moisture emanating from the end regions of the food product 10 can be expelled from the package 20 through the open ends of the package 20 during cooking. In order to adequately vent moisture from the medial region of the food product 10, the present invention advantageously provides venting apertures 45 adjacent to the medial region of the food product 10. As a result of the package 20 having openings on the ends as well as venting apertures in an embodiment of the invention, moisture can be vented from both the end regions and the medial region of the food product with uniformity and in a convenient and efficient manner.

The food product 10 of the present invention can be a frozen or non-frozen food. As a result, the microwave cooking package of the present invention can be utilized to thaw frozen food products, cook unfrozen food products, or thaw and cook a food product that is initial at least partially frozen.

In the drawings and specification, there have been disclosed various illustrated embodiments of the invention and, although specific terms are employed, they are used in a generic and descriptive sense only and not for the purpose of limitation, the scope of the invention being set forth in the following claims.

That claimed is:

1. A combination dough enclosed food product and microwave cooking package comprising:
a dough enclosed food product; and
a microwave cooking package adapted to contact and substantially surround the food product when the food product is cooked in a microwave oven, the package comprising a first layer of paper material, a second layer of microwave susceptor material, and a third outermost layer of paper material, the first, second and third layers being positioned so that the second layer of microwave susceptor material lies between the first and third layers of paper material and defines a second inner layer, the second inner layer of microwave susceptor material including a plurality of susceptor zones, each susceptor zone being adapted to reflect microwaves away from a respective adjacent region of the food product in an amount sufficient to prevent overcooking of the region of the food product when the combination food product and microwave cooking package is heated by the application of microwaves in the microwave oven.

2. A combination dough enclosed food product and microwave cooking package according to claim 1, wherein the microwave cooking package has a plurality of venting apertures formed in the first, second, and third layers to thereby allow moisture located on an outer surface of the food product to escape from the microwave cooking package when being heated in the microwave oven.

3. A combination dough enclosed food product and microwave cooking package according to claim 1, wherein the microwave cooking package comprises a tubular sleeve having at least one open end and the respective first, second, and third layers, and wherein the food product is adapted to be inserted into the open end of the sleeve to thereby substantially surround the food product prior to heat being applied when in the microwave oven.

4. A combination dough enclosed food product and microwave cooking package according to claim 2, wherein the plurality of susceptor zones comprises a first susceptor zone positioned along a first end portion of the microwave cooking package, a second medial susceptor zone positioned adjacent the first susceptor zone, and a third susceptor zone positioned along a second end portion of the microwave cooking package and adjacent the second medial susceptor zone, the first, second and third susceptor zones being aligned so that the second medial susceptor zone is positioned between the first and third susceptor zones, and wherein the venting apertures are formed in the section of the microwave cooking package adjacent to the second medial susceptor zone.

5. A combination dough enclosed food product and microwave cooking package according to claim 1, wherein at least two of the susceptor zones are positioned spaced apart from one another in the cooking package.

6. A combination dough enclosed food product and microwave cooking package according to claim 4, wherein the first and third susceptor zones have optical densities in the range of 0.38 to 0.42.

7. A combination dough enclosed food product and microwave cooking package according to claim 4, wherein the second medial susceptor zone has an optical density in the range of 0.15 to 0.20.

8. A combination dough enclosed food product and microwave cooking package according to claim 1, wherein each susceptor zone has an optical density sufficient to prevent overcooking of the region of the food product adjacent to the respective susceptor zone.

9. A combination dough enclosed food product and microwave cooking package according to claim 4, wherein the food product has a first region positioned adjacent to the first susceptor zone, a second medial region adjacent to the second medial susceptor zone, and a third region adjacent to the third susceptor zone, and wherein the first and third susceptor zones are more highly reflective than the second susceptor zone to prevent overcooking of the first and third regions of the food product.

10. A combination dough enclosed food product, microwave cooking package and packaging film comprising:
a dough enclosed food product;
a microwave cooking package, the package including at least one layer of microwave susceptor material having a plurality of susceptor zones, at least two of the susceptor zones having different optical densities; and
a packaging film substantially surrounding the food product and microwave cooking package to secure the food product and cooking package therewithin.

11. A combination dough enclosed food product, microwave cooking package and packaging film according to claim 10, wherein the microwave cooking package comprises a tubular sleeve, and wherein the sleeve is compressed within the packaging film.

12. A microwave cooking package comprising at least one layer of microwave susceptor material having a plurality of susceptor zones, at least two of the susceptor zones having different optical densities, the package having a plurality of venting apertures formed in the susceptor material to allow moisture to exit the package.

13. A microwave cooking package according to claim 12, wherein the plurality of susceptor zones are positioned along the longitudinal extent of the package, and wherein at least two of the susceptor zones are positioned spaced apart from one another in the cooking package.

14. A microwave cooking package according to claim 12, wherein the combined area of the plurality of venting apertures is at most 20% of the surface area of the microwave cooking package.

15. A combination frozen food product and microwave cooking package comprising:
a frozen food product; and
a microwave cooking package that intimately contacts the food product as the food product is cooked in a microwave, the package including at least one layer of microwave susceptor material that substantially surrounds the food product, the layer of microwave susceptor material comprising a plurality of susceptor zones positioned along the longitudinal extent of the cooking package and aligned adjacent to selected regions of the food product during cooking such that each susceptor zone reflects microwaves away from a respective adjacent region of the food product in an amount sufficient to prevent overcooking of said region of the food product.

16. A combination frozen food product and microwave cooking package according to claim 15, wherein the microwave cooking package has a plurality of venting apertures formed therein to allow moisture on an outer surface of the food product to escape from the package during cooking.

17. A combination frozen food product and microwave cooking package according to claim 15, wherein the microwave cooking package comprises a tubular sleeve having at least one open end, and wherein the food product is adapted to be inserted into the open end of the sleeve to thereby substantially surround the food product.

18. A combination frozen food product and microwave cooking package according to claim 17, whereby at least one end of the tubular sleeve protrudes at least 2 inches past the adjacent end of the food product when the food product is inserted into the sleeve and the sleeve substantially surrounds the food product.

19. A combination frozen food product and microwave cooking package according to claim 15, wherein the plurality of susceptor zones comprise a first susceptor zone, a second medial susceptor zone, and a third susceptor zone, the first, second and third susceptor zones aligned so that the second medial susceptor zone is positioned between the first and third susceptor zones, and wherein the venting apertures are formed in the section of the microwave cooking package adjacent to the second medial susceptor zone.

20. A combination frozen food product and microwave cooking package according to claim 15, wherein the first and third susceptor zones have an optical density in the range of 0.38 to 0.42.

21. A combination frozen food product and microwave cooking package according to claim 15, wherein the second medial susceptor zone has an optical density in the range of 0.15 to 0.20.

22. A combination frozen food product and microwave cooking package according to claim 15, wherein each susceptor zone has an optical density sufficient to prevent overcooking of the respective adjacent region of the food product.

23. A combination frozen food product and microwave cooking package according to claim 15, wherein the food product has a first region adjacent to the first outermost susceptor zone, a second medial region adjacent to the second medial susceptor zone, and a third region adjacent to the third susceptor zone, and whereby the first and third susceptor zones are more highly reflective than the second medial susceptor zone to prevent overcooking of the first and third regions of the food product.

24. A method of forming a microwave cooking package for cooking a food product comprising:
positioning a first layer of paper, a second layer of microwave susceptor material, and a third layer of paper so that the first and third layers of paper are the outermost layers of a packaging material;
forming a plurality of venting apertures in the packaging material; and
shaping the packaging material into a tubular sleeve adapted to intimately contact and substantially surround the food product when the food product is positioned therein such that moisture on the outer surface of the food product is expelled from the sleeve through the plurality of venting apertures when the food product is being cooked in a microwave oven.

25. A method of forming a microwave cooking package for cooking a frozen food product comprising:
positioning a first layer of material, a second layer of microwave susceptor material, and a third layer of material so that the first and third layers of material are the outermost layers of a packaging material;
forming a plurality of venting apertures in the packaging material; and
shaping the packaging material into a tubular sleeve adapted to intimately contact and substantially surround the food product when the food product is positioned therein such that moisture on the outer surface of the food product is expelled from the sleeve through the plurality of venting apertures when being cooked in a microwave oven.

26. A combination dough enclosed food product and microwave cooking package comprising:
a dough enclosed food product; and
a microwave cooking package adapted to contact and substantially surround the food product when the food product is cooked in a microwave oven, the package comprising a first layer of paper material, a second layer of microwave susceptor material, and a third outermost layer of paper material, the first, second and third layers being positioned so that the second layer of microwave susceptor material lies between the first and third layers of paper material and defines a second inner layer, the second inner layer of microwave susceptor material including a plurality of susceptor zones, at least one susceptor zone being adapted to reflects microwave energy away from a respective adjacent region of the food product in an amount sufficient to prevent overcooking of the region of the food product and at least one other susceptor zone being adapted to conduct and absorb microwave energy in order to provide heat for cooking at least a respective adjacent other region of the food product when the combination food product and microwave cooking package is heated by the application of microwaves in the microwave oven.

27. A combination dough enclosed food product and microwave cooking package according to claim 26, wherein each susceptor zone has an optical density sufficient to prevent overcooking of the region of the food product adjacent to the respective susceptor zone.

28. A combination dough enclosed food product and microwave cooking package according to claim 26, wherein the first and third susceptor zones have optical densities in the range of 0.38 to 0.42 and the second medial susceptor zone has an optical density in the range of 0.15 to 0.20.

29. A combination dough enclosed food product and microwave cooking package according to claim 26, wherein the first and third susceptor zones each have optical densities in the range of 20% to 200% higher than the optical density of the second medial susceptor zone.

30. A combination dough enclosed food product and microwave cooking package according to claim 26, wherein the microwave cooking package has a plurality of venting apertures formed in the first, second, and third layers adjacent to the susceptor zone adapted to conduct and absorb microwave energy to thereby allow moisture from the food product to escape from the microwave cooking package when being heated in the microwave oven.

31. A combination dough enclosed food product and microwave cooking package according to claim 26, wherein the plurality of susceptor zones comprises a first susceptor zone positioned along a first end portion of the microwave cooking package, a second medial susceptor zone, and a third susceptor zone positioned along a second end portion of the microwave cooking package, the first, second and third susceptor zones being aligned so that the second medial susceptor zone is positioned between the first and third susceptor zones, and wherein the venting apertures are formed in the section of the microwave cooking package adjacent to the second medial susceptor zone.

32. A combination dough enclosed food product and microwave cooking package according to claim 26, wherein the food product has a first region positioned adjacent to the first susceptor zone, a second medial region adjacent to the second medial susceptor zone, and a third region adjacent to the third susceptor zone, and whereby the first and third susceptor zones are more highly reflective than the second susceptor zone to prevent overcooking of the first and third regions of the food product.

33. A combination dough enclosed food product, microwave cooking package and packaging film comprising:
a dough enclosed food product;
a microwave cooking package, the package including a plurality of susceptor zones, each susceptor zone containing at least one layer of microwave susceptor material, at least two of the susceptor zones having different optical densities to provide different amounts of conductance and absorbance of microwave energy for cooking respective adjacent regions of the food product when the food product is substantially surrounded by the microwave cooking package and heated by the application of microwaves in the microwave oven; and
a packaging film substantially surrounding the food product and microwave cooking package to secure the food product and cooking package therewithin.

34. A combination dough enclosed food product, microwave cooking package and packaging film according to claim 33, wherein the microwave cooking package comprises a tubular sleeve, and wherein the sleeve is compressed upon being secured within the packaging film.

35. A method of forming a microwave cooking package for cooking a frozen food product comprising:
forming a plurality of venting apertures in a packaging material;
shaping the packaging material into a sleeve; and
shaping the food product to be intimately contacted and substantially surrounded by the sleeve such that when the food product is cooked in a microwave oven, the moisture on the outer surface of the food product is expelled from the sleeve through the venting apertures.
